(19) United States
(12) Patent Application Publication
(10) Pub. No.: US 2005/0149507 A1
(43) Pub. Date: Jul. 7, 2005

(54) Systems and methods for identifying an internet resource address

(76) Inventor: Timothy G. Nye, Guelph (CA)

Correspondence Address: HAMILTON, BROOK, SMITH & REYNOLDS, P.C., 530 VIRGINIA ROAD, P.O. BOX 9133, CONCORD, MA, 01742-9133, US

(21) Appl. No.: 10/959,913

(22) Filed: Oct. 6, 2004

Related U.S. Application Data
(63) Continuation of application No. 10/772,784, filed on Feb. 5, 2004.
(60) Provisional application No. 60/444,874, filed on Feb. 5, 2003.

(51) Int. Cl. G06F 17/30

(52) U.S. Cl. 707/3

(57) ABSTRACT

Systems and methods are provided for identifying information about an entity. The entity may be a business or service. Information about the entity can be determined by processing any attributes known about the entity, such as a phone number, business name, or address. For example, information, such as an internet address of a business can be determined from the phone number of the business. With the phone number of the business, a number of potential internet addresses for that business may be determined. A single address, which is likely to be that of the business, can be determined by processing the potential internet addresses using tuning techniques and pattern recognition algorithms. A database of websites associated with directories or portals may be created using attributes known about a plurality of entities.

### RELATED APPLICATIONS

This application is a continuation of U.S. application Ser. No. 10/772,784, filed Feb. 5, 2004, which claims the benefit of U.S. Provisional Application No. 60/444,874, filed on Feb. 5, 2003. The entire teachings of the above applications are incorporated herein by reference.

### BACKGROUND

The Internet has become a major source for valuable information relating to products and services available for sale. The amount of information on the web is growing rapidly, as well as the number of new users who are inexperienced in the art of web research. Increasingly, information gathering and retrieval services are faced with a market full of users that want to be able to search for very specific information, as quickly as possible, and without being burdened with false positives.

Typically, it is difficult for a user to locate the website of a business even if the exact name and city location of the business is known and used. Consumers, for example, want to input minimal information as search criteria and in response, they want specific, targeted and relevant information. Being able to match a consumer's query to a proper business name is very valuable, as it can drive a transaction, such as a sale. Accommodating these demands effectively, unfortunately requires human intelligence, which is not easily captured into a search engine or index scheme without investing in an involved and expensive process. The difficulties of this process are compounded by the unique challenges that companies face to make their presence known to consumers in this dynamic global environment.

For example, a user sees a television commercial for a restaurant in the city of Boston called “Bertucci's” and wants to visit the website of “Bertucci's” to obtain more information, such as to see its menu. The user enters the keywords “Boston Bertucci's” into a web search engine, such as the one at www.google.com or www.yahoo.com. The user may receive, for example, a list of 876 matches, but find that the actual Uniform Resource Locator (URL) for the restaurant is not anywhere in the search results. Sometimes the desired match may be returned but buried so deeply in the search results that the user is unable to find the match even if they have the patience to sift through the entire search result list. Further, if the user interface is a Voice Over IP (VoIp) interface, where the search results are audibly read back to the user, the sifting process may take hours and therefore, for most purposes is impractical.

There are directories or portals on the Internet that maintain databases relating to specific content such as for example a database of restaurants, for searching by users. Users may query these databases for a more manageable set of search results. However, the Internet is a fluid and dynamic medium where the available information is consistently being edited and expanded. After data has been collected for these databases, the data soon becomes stale as new data is published. Further, in some cases, these large databases yield search result lists that are too long. Ideally users want to go to one place rather than maintain a collection of many different resources depending on the type of query.

Consequently, there is no reliable and efficient method for users to find the website of a particular business or entity on the Internet. Search engines are hit and miss, and they yield an overwhelming amount of false positive hits that require users to spend significant amounts of review time in order to locate the correct website address. Further, even if there is a directory or portal that has the desired subject matter with the website addresses, these directories or portals do not provide much of an improvement because they are expensive to develop and maintain. The majority of these portals and databases are simply republishing portions of existing databases, such as the yellow pages, and this information can become stale within a short period of time.

Outside of the Internet, users may call businesses to ask for their website addresses, but this only works when the businesses are open. From a business point of view, this process expends time and money to provide the requested information. Further, calling businesses is not always reliable as callers are frequently passed to automated attendants.

Another source of business information is the Yellow Pages, but website addresses are not usually provided except in some of the advertisements. Also, with the printed version of the Yellow Pages, the problem of staleness is even worse as compared to information available on the Internet.

In today's dynamic global environment, the critical nature of speed and accuracy in information retrieval can mean the difference between success and failure for a new product or even a company. Consumers want specific information quickly, such as the website address of a business. In addition, the user may want to know about other businesses that may also carry that the same products or similar products as those offered by that business. The current information gathering and retrieval schemes are unable to efficiently provide a user with such targeted information. Nor are they able to accommodate the versatile search requests that a user may have.

Thus, one of the most complicated aspects of developing an information gathering and retrieval model is finding a scheme in which the cost benefit analysis accommodates all participants, i.e. the users, the businesses, and the search engine providers. At this time, the currently available schemes do not provide a user-friendly, provider-friendly and financially-effective solution to provide easy and quick access to specific information.

### SUMMARY

The present invention relates to methods and systems for generating highly targeted searches. While the invention may be used to identify any attribute of any entity, preferably, the attribute identified is a URL address of an entity. A URL address of the entity may be determined based on information known about the entity, such as a verified attribute of the entity. Computational and prediction techniques may be used by the system in analyzing and tuning search results to eliminate false positives and determine the entity's URL address.

In one embodiment, an attribute of an entity, such as a business's telephone number, may be used to determine another attribute of the business, such as the business's Internet address (URL address). In this example, a telephone number may be submitted to one or more search engines, and in response, a list of URL addresses may be generated. Web content may be collected from the website located through the URL address. Alternatively, indexed content associated with the URL address, which has been provided by the search engine, may be used. The content may be parsed to locate a URL address or email address. The number of times a unique URL address appears throughout all content parsed is computed. If the computed value is above a threshold value, the URL may be an accurate address. A process is performed to eliminate false positives in addresses identified by a search. The URL address that has the highest ranking value may be considered the correct URL address for the entity. The URL address determined to be correct may be used to update a persistent storage, such as a database that stores a collection of information in an ongoing manner.

The process of verifying candidate URL addresses and identifying the correct match enhances the validity of the records in the database. For example, the website content that has been collected for candidate URL addresses may be stored in a table associated with the respective URL address. This provides the database with updated indexed content. When the correct match for a business's URL address is identified, the system updates the record in the database associated with the business. This record may include predefined data that has been obtained from an independent entity, such as the yellow pages, which may include the business's name, phone number, address, and business activity heading. The system may update the record to further include content that can be associated with the entity, such as any URL addresses, email addresses, and website information. Thus, to the great benefit of the user, the system determines the correct URL address of a business by using the business's phone number, and thus, with this phone number, the system can connect the business to its URL address and web content.

The system may include one or more preprocessing techniques that filter search result hits produced by one or more search engines. These preprocessing techniques can tune the search results and assign a confidence level to potential matches. Using preprocessing techniques, the system may identify a match without having to expend substantial system resources, such as bandwidth, because the system can identify a URL match quickly by analyzing attributes of URL addresses identified in search results and extracting website content of a few of search results to verify the accuracy of the results of the URL analysis.

The system may include a tuning process that performs URL pattern recognition techniques to quantify the degree of similarity between the domain name of a hit and the name of a desired business. The tuner may compare the domain name to the business name and identify matching attributes. If there is, for instance, an exact match, a high confidence level may be assigned to the hit. It should be noted that the tuner, preferably, ignores stop words associated with the legal entity status of the business, e.g., Corporation, Incorporated, Limited Liability Company, etc.

An initial analysis technique may be used to analyze abbreviations formed out of the initials of words contained in the name of the desired business. The system may check to determine whether the initials of the business name are also contained in the domain name. For example, if the business name is International Business Machines Corporation, the system would determine that the initials for the business are “IBM”. If one of the URLs identified in the search hits is www.ibm.com, the system would identify an exact match.

A string matching process (words analysis technique) may be used to analyze whether any words contained in the business name match words contained in the domain name of a URL. This technique evaluates a hit by quantifying the relationship between the words contained in the business's name and the words contained in the domain name. A numerical estimate of the similarity between the two strings is computed. This computation might be based on the number of characters the strings have in common. Each word string is compared and the number of positions where sequences differ are computed. The sum of the squared differences can be used in determining the margin of error and assigning a score to the match. The score reflects the results of the word string matching analysis.

Distance matching techniques may be used to evaluate a search result hit by computing the number of characters that need to be added, deleted or changed to transform a business name string into the domain name string associated with the hit. For example, the Levenshtein distance algorithm may be used. The Levenshtein distance D(x,y), between strings the business name string, x, and the domain name string, y, is the minimum number of character insertions and/or deletions required to transform string x into string y.

The system may analyze the URL address of a hit to determine whether it corresponds to the opening or main page of the website (the homepage). A URL that does not correspond to the homepage is usually a good indication that the website does not correspond to the desired business.

If the results of preprocessing identify a hit that is determined to sufficiently accurate, the system may proceed to verify the hit by extracting and evaluating website content. This can enable the system to deliver quick and accurate results to the user.

In another embodiment, the system may develop search processes to identify URLs that correspond to directories and portals. Search engines may be queried using a plurality of verified attributes of a plurality of entities. For example, a search process may formulate search queries based on verified attributes (e.g., business names, phone numbers, etc.) listed in the yellow pages. The website content of the search results received may be examined to determine whether any of the search results are likely to correspond to a directory or portal.

If the system determines that the website contains a substantial amount of verified attributes, the website address may be added to a collection of URLs that correspond to directories and portals. The system can use this collection of URLs to filter out false positives of search results received in response to a query for a URL address of a business.

The system may determine whether the directory or portal corresponds to a particular classification or business category by creating queries for several businesses that relate to a specific business category. For instance, the system may identify several businesses listed in the yellow pages that are under the category Restaurants. A query may be formulated based on such a list of restaurants identified in the yellow pages. The system can query several search engines using the verified restaurant data as search criteria. If a portal or directory is identified that references a substantial number of the verified attributes associated with the restaurant businesses, then the system may determine that the website portal or directory relates to restaurants. In this way, the system can create a collection of websites portals that relate to specific subject matter.

Using a collection of information, such as a collection of website portals, the system can generate highly targeted searches for users by cross-referencing and narrowing search results. The collection of information may be used to focus a user's search to a particular subject matter. Specialized filtering and parsers may be used to narrow search results.

### BRIEF DESCRIPTION OF THE DRAWINGS

The foregoing and other objects, features and advantages of the invention will be apparent from the following more particular description of preferred embodiments of the invention, as illustrated in the accompanying drawings in which like reference characters refer to the same parts throughout the different views. The drawings are not necessarily to scale, emphasis instead being placed upon illustrating the principles of the invention.

FIG. 1 is a block diagram of the systems architecture of a information gathering and retrieval system according to an embodiment of the present invention.

FIG. 2A is a flow diagram of a search process for locating a website address of an entity based on an attribute of the entity according to an embodiment of the present invention.

FIG. 2B is a flow diagram of a search process for locating a website address of an entity based on an attribute of the entity using a pretuning process in accordance with an embodiment of the present invention.

FIG. 2C is a flow diagram of a process for creating a database of websites correspond to directories, news sites, or portals.

FIG. 2D is a graph generated in accordance with the process shown in FIG. 2C.

FIG. 3 is a flow diagram of a process for identifying unknown information about an entity.

FIGS. 4A and 4B are flow diagrams of the process for locating a website address of an entity based on an attribute of the entity in accordance with the present invention.

FIG. 5 is a graph of hits versus URL of a sample search result.

FIG. 6 is a flow diagram of the process for using a database as a filter for a search query according to an embodiment of the invention.

### DETAILED DESCRIPTION OF THE INVENTION

A description of preferred embodiments of the invention follows.

System Architecture

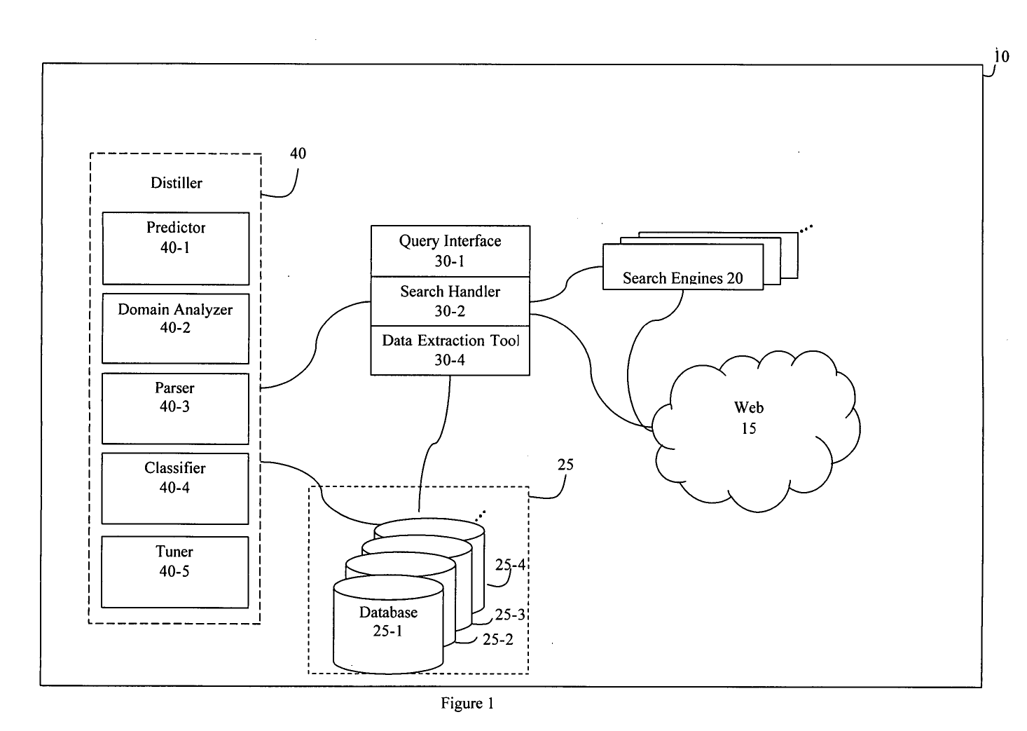

Preferably, the invention is implemented in a software or hardware environment. One such environment is shown in FIG. 1. In this example, an information gathering and retrieval system 10 is provided for generating highly targeted searches. Although the search process may be implemented as a search engine, it may be desirable to provide a search handler 30-2, which utilizes a plurality of existing search engines 20 available on the web 15, such as Google or Yahoo. Content from websites identified in the search results produced by the search engines 20 may be extracted using a data extraction tool 30-4 to collect relevant information.

The system 10 uses a collection of information 25 to optimize searching. The collection of information 25 may include a number of different types of databases 25-1, 25-2, . . . 25-n. Preferably, the collection of information 25 includes one or more databases containing verified information 25-1, such as Yellow Pages listings, Better Business Bureau membership list, AARP membership list, etc. In addition, the collection of information may include a list of known directory websites 25-2, such as news websites, business directories, portals, etc. A particular collection of information 25-3, which relates to a user's search query, such as a database that contains a listing of restaurants, products and associated businesses, may be provided or selected by a user at a query interface 30-1. The collection of information 25 may further include a collection of indexed content 25-4 from websites of businesses or entities. The system 10 determines the appropriate databases 25-1, 25-2, . . . 25-n to use during the search based on the content of the user's search query and the results of the query. The user also has the ability to select a database 25-1, 25-2, . . . 25-n.

In performing a search analysis, the search handler 30-2 interfaces with the distiller 40 to eliminate false positives from the search results provided by the search engines 20. Preferably, the distiller 40 includes a predictor module 40-1, domain name analyzer 40-2, parsers 40-3, classifiers (content analyzer) 40-4 and tuner 40-5. The predictor 40 is used to predict which URL addresses identified in the search results are likely to be accurate. The domain name analyzer 40-2 is used to analyze domain names in URL addresses identified in the search results. One or more parsers 40-3 may be used by the system 10 to target the user's search query to a specific context. The classifier 40-4 analyzes and classifies content that has been extracted from the websites of entities using the data extraction tool 30-4. The classified content is indexed and stored in the database 25-4. The tuner 40-5 is used to pre-tune the search results received from the search engines 20. The features of the distiller 40 (40-1, 40-2, . . . , 40-5) are discussed in more detail below.

Search Process

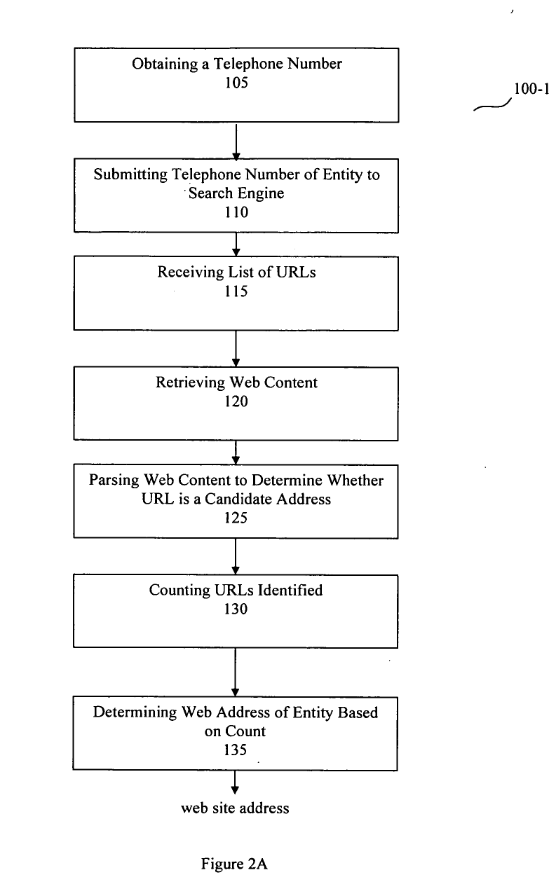

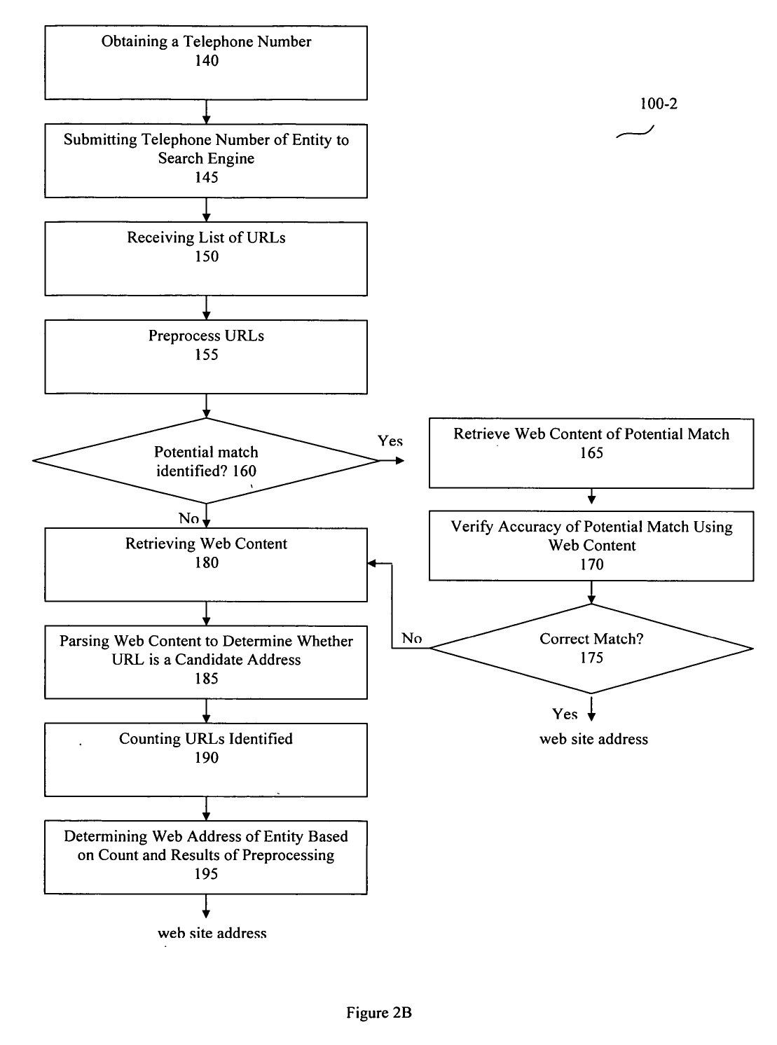

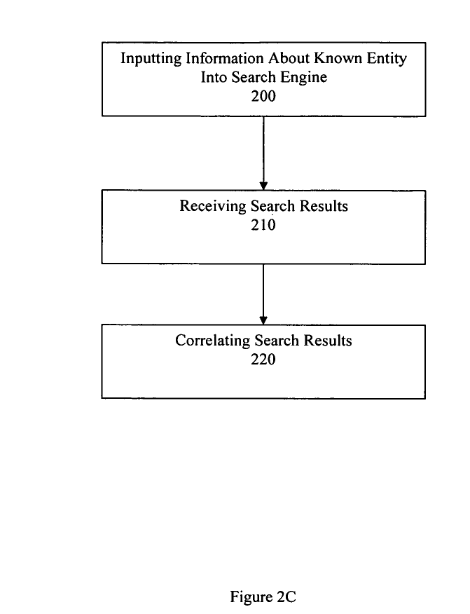

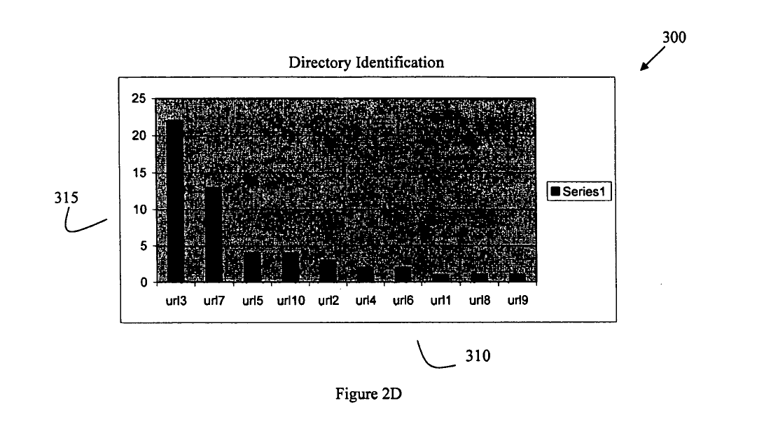

FIG. 2A shows a search process 100-1 for locating the website address of an entity based on an attribute of the entity in accordance with an embodiment of the present invention. The process 100-1 may be implemented in software or hardware. Preferably, the process 100-1 is implemented by the system 10 of FIG. 1. The process 100-1 involves obtaining a telephone number of the entity of interest at 105 (for example, from database 25-1 or 25-n) and submitting the telephone number to several web based search engines at 110. A list of URL addresses is received from the search engines at 115. The content of each potential match is extracted from the respective website at 120. The extracted content is parsed to identify email and website addresses therein at 125. Each unique website address that has been identified is counted at 130. In particular, the number of occurrences of an email address or a website address in the website content, which corresponds to the URL addresses obtained from the search engines is determined. The URL address of the entity is then determined based on the count provided by the predictor module 40-1 at 135.

In one embodiment, a telephone number is submitted as a keyword to one or more search engines. Alternately, keywords based on other known attributes of the entity such as address, business name, or combinations, including telephone numbers, thereof may be submitted to the search engines. Those skilled in the art will understand that other verified attributes can be used such as product names carried by the business.

Referring to FIG. 1, a predictor module 40-1 is used to determine which website address has the most hits as a match for the website address of the entity of interest. In the case where a plurality of unique website addresses have the same number of hits, the predictor module deems all such website addresses to be matches for the website of the entity of interest.

Preprocessing Search Results

FIG. 2B shows a search process 100-2 for locating the website address of an entity based on an attribute of the entity using a pretuning process in accordance with an embodiment of the present invention. The process 100-2 is similar to 100-1 of FIG. 2A, but includes a pretuning (preprocessing) technique. For example, at 140, the entity's telephone number is obtained. At 145, the telephone number is submitted to one or more search engines; and at 150, a list of URLs is obtained from the search engines. At 155, the URLs are preprocessed. It should be noted that preprocessing 155 may occur at various stages in the process 100-2. For example, it may occur after the web content is retrieved 180, or it may occur in parallel with the web content retrieval 180.

Preprocessing involves tuning the hits using multiple methods. Referring to FIGS. 1 and 2B, by preprocessing the hits, the system 10 is able to identify a potential match and verify whether it is authentic. In this way, the system 10 may identify a match without having to expend system resources, such as bandwidth, because the system 10 does not need to continue extracting the indexed content for a substantial amount of hits received from the search engine server 20.

At 160, the system 10 may use software components, such as the tuner 40-5, to preprocess and filter the hit data to identify potential matches. For example, the tuner 40-5 uses URL pattern recognition techniques to quantify the degree of similarity between the domain name of a hit and the business's name. The tuner 40-5 compares the domain name to the business name and identifies matching attributes. If there is an exact match, for instance, a high confidence level is assigned to the hit. It should be noted that the tuner 40-5 ignores the legal entity status of the business's name, e.g. Corporation, Incorporated, Limited Liability Company, etc.

The tuner 40-5 may use any of the following techniques to evaluate and rank a hit, and determine if it is a potential match. It should be understood that these techniques are examples of preferred preprocessing techniques performed by the pretuner 40-5, and that any preprocessing technique to tune can be used.
Initial analysis techniques are used to evaluate a hit by determining the initials of the business name and analyzing the domain name of the hit for a match. In particular, abbreviations formed out of the initials of words contained in the business name are determined. For example, if the business name is International Business Machines Corporation, the tuner 40-5 would determine that the initials for the business are “IBM”. If one of the domain names identified in the search hits is www.ibm.com, the tuner 40-5 would identify an exact match.
Word matching techniques are used to evaluate a hit by determining the degree of similarly between the words contained in the business's name and the words contained in the domain name. This measures the similarity and computes a numerical estimate of the similarity between the two strings. This computation might be based on the number of characters the strings have in common. Each word string is compared, and the number of positions where sequences differ are computed. The sum of the squared differences can be used in assigning a score to the match. The score reflects the results of the word string matching analysis.
Distance matching techniques are used to evaluate a hit by computing the number of characters that need to be added, deleted or changed to transform the business name string into the domain name string associated with the hit. For example, the Levenshtein distance algorithm may be used. The Levenshtein distance D(xy), between strings the business name string, x, and the domain name, y, is the minimum number of character insertions and/or deletions required to transform string x into string y. In general, the distance measurement, D, reflects the minimum cost of transforming x into y.
The URL address of the hit may be examined to determine whether it corresponds to the opening or main page of the website (the homepage). A URL that does not correspond to the homepage is usually a good indicator that the website does not correspond to the desired business.

The tuner 40-5 may use any of the above listed techniques to evaluate a hit. The results of each technique can be stored in, for example, a feature vector associated with the hit. The attributes of each feature vector associated with each hit can be compared and ranked. The hits that are ranked the highest, may be used by the system 10 to determine candidate matches. At 160, if preprocessing provides a hit that is determined to be 93% accurate, the system 10 may proceed to verify the hit by extracting and evaluating website content 165. If the evaluation confirms that the hit is a match at 170, the system 10 can therefore eliminate the possibility that there may be a need to evaluate the content of a substantial amount of websites (180-195). This enables the system 10 to deliver quick and accurate results to the user at 175.

Evaluating Content

Referring to FIG. 1, the following is an example of a search for a website address of an entity performed by the distiller 40. A telephone number of a business is entered into one or more web-based search engines 20 to locate the website address for the business. Where a telephone number is not available, a business name may be entered for lookup on a Yellow Page database 25-1 or 25-n to obtain the telephone number of the business. The telephone number is then submitted to the search engines 20 with appropriate query operators to indicate a phrase, such as with quotes around the telephone number, or portions of the telephone number may be submitted. In this way, the system 10 can increase the accuracy of its search.

From the search result hits returned by the search engines 20, the URL addresses of the first n search result hits are collected and recorded. The number n may vary. The distiller 40 may work even with a minimal number of search result hits, such as for example, ten. Notwithstanding resource and time constraints, there is, of course, no limit to the number of search result hits that can be processed. However, processing more than one hundred search result hits does not appear to significantly improve the confidence level of a matched or detected website address. Duplicate URL addresses in the set of search results are not counted twice.

For the URL addresses in the first n search result hits, the data extraction tool 30-4 is used to download the web content at each URL. The downloaded web content is parsed by the parser 40-3 for website addresses and email addresses, which are compiled as follows:

For the first URL, for example, at www.somesite.com, the following email and website address are identified:
bob@company1.com
fred@company1.com
www.company1.com
sarah@company2.com
www.company2.com
www.company2.com
www.company3.com
bill@company1.com

Each occurrence of a website address and email address is identified and counted as follows for the first URL:
bob@company1.com is an email address and one count is added for website address “company1.com”.
fred@company1.com is an email address, however, since it has the website address “company1.com”, it is considered a “duplicate” website address and is not counted again.
www.company1.com is a website address and another count is added for website address “company1.com”.

In summary chart form, the email and website addresses associated with the first URL are compiled as:

| | | |
|---|---|---|
| bob@company1.com | Email | +1company1.com |
| fred@company1.com | Email | Duplicate |
| www.company1.com | Website | +1company1.com |
| sarah@company2.com | Email | +1company2.com |
| www.company2.com | Website | +1company.com |
| www.company2.com | Website | Duplicate |
| www.company3.com | Website | +1company3.com |
| bill@company1.com | Email | Duplicate |

For the second URL, the following email and website addresses are identified:
mrsmith@newfirm1.com
mrjones@newfirm2.com
www.company2.com
www.newfirm2.com

The email and website addresses associated with the second URL are compiled as:

| | | |
|---|---|---|
| mrsmith@newfirm1.com | Email | +1newfirm1.com |
| mrjones@newfirm2.com | Email | +1newfirm2.com |
| www.company2.com | Website | +1company2.com |
| www.newfirm2.com | Website | +1newfirm2.com |

For the third URL, the following email and website addresses are identified:
www.company2.com
www.anotherfirm1.com

The email and website addresses associated with the third URL are compiled as:

| | | |
|---|---|---|
| www.company2.com | Website | +1company2.com |
| www.anotherfirm1.com | Website | +1anotherfirm1.com |

For the fourth URL, the following email and website addresses are identified:
mrbrown@newfirm3.com
mrjjones@newfirm2.com
www.company2.com
sarah@company2.com
www.anotherfirm2.com

The email and website addresses associated with the fourth URL are compiled as:

| | | |
|---|---|---|
| mrbrown@newfirm3.com | Email | +1newfirm3.com |
| mrjones@newfirm2.com | Email | +1newfirm2.com |
| www.company2.com | Website | +1company2.com |
| sarah@company2.com | Email | +1company2.com |
| www.anotherfirm2.com | Website | +1anotherfirm2.com |

This process continues for each URL of the first n search result hits.

Processing Matches

After each URL has been compiled for the first n search results, as noted above, the compiled results are added to a master table to create running totals as follows (assuming four URL addresses have been processed):

| | Emails and Websites | Websites only (n = 4) |
|---|---|---|
| Company1 | 2 | 1 |
| Company2 | 6 | 4 |
| Company3 | 1 | 1 |
| Newfirm1 | 1 | 0 |
| Newfirm2 | 3 | 2 |
| Anotherfirm1 | 1 | 1 |
| Newfirm3 | 1 | 0 |
| Anotherfirm2 | 1 | 1 |

After processing twenty URL addresses, for example, the running totals may be:

| | Email and Websites | Websites only |
|---|---|---|
| Company1 | 3 | 1 |
| Company2 | 28 | 19 |
| Company3 | 1 | 1 |
| Newfirm1 | 1 | 0 |
| Newfirm2 | 8 | 3 |
| Anotherfirm1 | 1 | 1 |
| Newfirm3 | 3 | 0 |
| Anotherfirm2 | 1 | 1 |
| . | | |
| . | | |
| . | | |
| Newfirm_x | 2 | 1 |

In the (n=4) running total example, the highest value 6 for Company2 is double that of Newfirm2. In the (n=20) running total example, Company2 has over three times the count of the combined total (Emails and Websites) and over six times the total count of Newfirm2.

The predictor 40-1 may be set to deem a match for a website address to be that of an entity when the highest count for a particular website is a multiple of the second highest count after processing a minimum number of x search result hits. As n increases, this ratio will also likely increase. Thus, processing of the search result hits may also stop after n (>x) URL addresses are processed when the prediction criteria for a website address determination is satisfied.

In a search for a business's website address, there may be cases where, for example, two website addresses have similar counts as shown in the following example:

| | Emails and Websites | Websites only |
|---|---|---|
| Company1 | 3 | 1 |
| Company2 | 28 | 19 |
| Company3 | 1 | 1 |
| Newfirm1 | 1 | 0 |
| Newfirm2 | 22 | 15 |
| Anotherfirm1 | 1 | 1 |
| Newfirm3 | 3 | 0 |
| Anotherfirm2 | 1 | 1 |
| . | | |
| . | | |
| . | | |
| hotmail.com | 24 | 0 |
| Newfirm_x | 2 | 1 |

In this case, Company2 and Newfirm2 are both considered to be matches for the website address of the business. There may be a number of reasons for this situation, such as for example, the business uses two URL addresses for its website, one URL was previously used but has been replaced and another URL is now being used, or that one URL is a false match and is actually a directory or news site. Known directories or news sites may be designated as false positives and be removed by filtering the URLs through the directory database 25-2.

Prediction Techniques

The predictor module 40-1 may be set to determine a match when a website address has a number count that is a multiple of either the mean or median count after processing a minimum number of x search result hits. Thus, both the Company2 and Newfirm2 website addresses may be identified as the website addresses of the business.

In another embodiment, the predictor module 40-1 may be based on a co-efficient (or threshold value) defined as the total matches of an individual URL divided by the number of matches to the original query, where correct matches exceed a certain coefficient value. The coefficient value may be determined by setting a value, which includes all or most of a set of known correct matches.

The distiller 40 may verify a website address by matching further attributes of the business, such as for example, the business name and address, to the content of the website linked to the website address. This feature is particularly important when one or more of the search engines return only a few search result hits. This could be due to a number of reasons including there is no website for the business, the website is not well represented in search engines, or the website is not well linked to/by other websites.

In these cases, a clear pattern may not be established from the search result hits, such as for example, the search results may yield only three or four possible hits and/or a small number of URL addresses. In this situation, the master table may include a list of website addresses, all with an associated count of two or three. Rather than identifying all of the website addresses as possible matches, the websites linked to each website address in the list are searched for the physical address and business name of the business of interest. For example, assume “Bob's Pizza, 123 Main Street, Chicago” is submitted, a telephone number of 123-555-1212 is returned, and the following five potential matches are identified in the search results:
URL_A
URL_B
URL_C
URL_D
URL_E

Each of the potential matches, URL_A to URL_E is visited and searched for the physical addresses. If only one physical address is found and it is 123 Main Street, then this URL is deemed to be a positive match. If several physical addresses are found, but only one of the addresses is 123 Main Street, then this URL may be a match, but it could also be a directory. If one or more physical addresses are found, but not 123 Main Street, then the URL(s) is not considered to be a match. The system 10 may utilize processing techniques to search for the physical address in graphical objects associated with the web page. Computer vision technology, such as optical character recognition techniques (OCR), can be used to identify the address in the graphics.

In addition, if any of the physical addresses on the web pages matches an address that is known not to be Bob's Pizza or the URL is known to be a directory or portal, then the predictor module 40-1 may be set to reject the particular URL in question.

Directory Identification

According to another aspect of the present invention, systems and methods to create and update a database of directory websites that include directories, news sites, or portals is provided. These are directory websites that display multiple addresses of other businesses in the regular course of business such as a Yellow Page directory, or newspaper site reporting news, or a local city portal. It should be noted that preferably, the process used to detect directories and portals, excludes certain types of businesses from its analysis. For example, for franchises that have a substantial amount of addresses and phone numbers, any site listing all of these phone numbers would not be considered a directory or portal website.

FIG. 2C depicts a process for locating a website address of an entity based on an attribute of the entity according to an embodiment of the present invention. A large number of known entities is sent to a search engine to yield a set of search result hits 200. The search results are received at 210 and correlated into a matrix at 220. One such matrix is shown in FIG. 2D.

FIG. 2D is a graph 300 generated in accordance with the process shown in FIG. 2C. The URL addresses collected as possible matches for the large number of known entities (e.g. list of telephone numbers for a plurality of businesses) are graphed on the X axis 310. The Y axis 315 is the number of times each URL occurs. The more often a URL occurs for different entities increases the chance that the URL is a directory. The larger the sample the more accurate the results. The process recognizes that franchises or businesses with more than one location will appear as directories but these can be easily identified as false positives because they share the same (or similar) entity name from the original list of known entities.

Because URL addresses of directories, such as Yellow Pages, portals or news sites tend to yield many more hits of verified attributes of a plurality of business entities, they stand out as directories for easy identification by the system. URL #3 and URL #7, for instance, may be easily identified as directories.

For instance, consider the situation where a local restaurant portal lists hundreds of restaurants in a given city. This portal would be identified by the system because it contains matches for hundreds of different restaurants. If the URL along the X axis 310 contained even as little as ten of these restaurants, this website would stand out as a directory and would automatically be added to the database of directory websites 25-2 of FIG. 1. Likewise, a news site, such as the Washington Post, may frequently include articles on particular businesses, and thus would also stand out during this process and be added to the database of directory websites 25-2. In other words, large multiple hits/matches above a certain threshold for a website can be identified on the matrix 300, and classified as a directory website. The selected threshold depends on the sample size and may be any positive number above two.

In another embodiment, the database of directory websites 25-2 is created using the processes illustrated in FIG. 2C. In this way, an index of directory websites can be provided that can be queried to locate directory websites or certain types of directory websites. It will be understood by those skilled in the art that the system 10 may be modified to rate directory websites by subject matter content. For example, a directory may be rated by the number of hits according to restaurants, types of restaurant, and locations of restaurants in its database. The system 10 can use the Yellow Pages database 25-1 to cross reference the restaurants listed. Thus, a user desiring access to a directory with restaurants in New York may be provided with a list ranked accordingly. The top restaurant directory website would be the one with the most hits of a sample set of restaurants from New York by that directory website. Furthermore, if a business, such as a restaurant, is listed in a number of portals and directories, this may be an indication of the quality of the restaurant. In this way, the collection of directories and portals may be used as a search filter to verify the quality of the business.

URL Identification

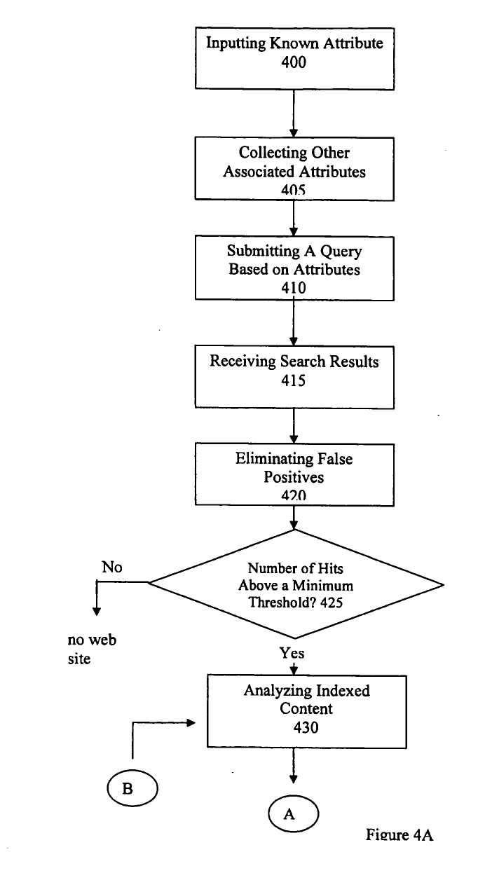

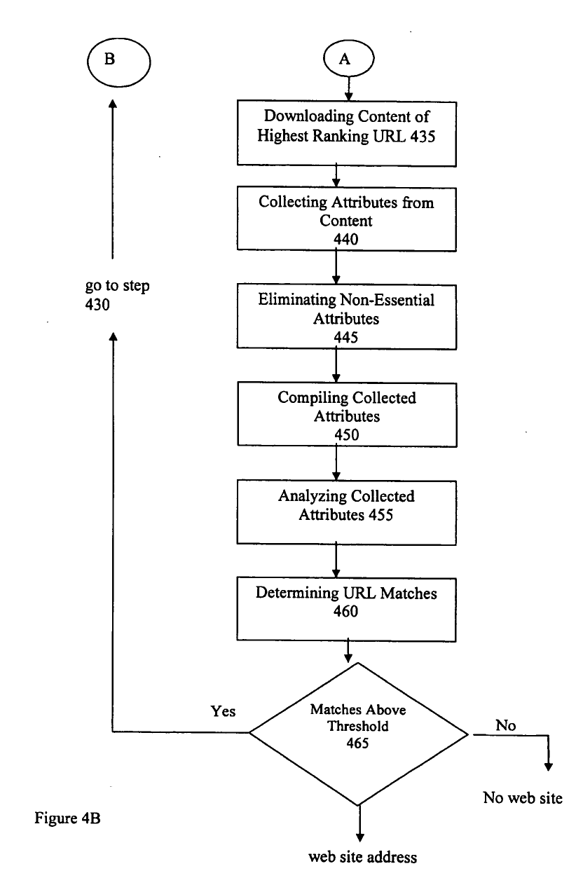

FIGS. 4A and 4B depict the process for locating a website address of an entity in accordance with an embodiment of the invention. An attribute that identifies an entity or business, such as, a telephone number, physical address or business name is selected at 400. Other attributes associated with the selected attribute are collected at 405. For example, a telephone number may be associated with a physical address, which can be obtained from a Yellow Pages database 25-1. A query to one or more search engines and any other databases of indexed content is submitted, using the selected attribute and one or more of the associated attributes at 410. The search results are received from the search engines and databases at 415. Preferably, each search result hit consists of a header, brief text description, and URL, as well as possibly other information that may be provided, such as indexed content. At 420, all false positives are removed from the search results. URL addresses are removed from the search results that are known to be associated with entities that are not the same entity described by the queried attributes. For example, URL addresses that are removed include URL addresses that correspond to a URL listed in the directory list 25-2 of FIG. 1 (e.g., directories, news sites, local portals, etc). If the number of search results hits is below a minimum threshold number n, than the entity is categorized as having no website at 425. For example, if n=0 then the entity is categorized as having no website. Otherwise, if n>0 but below a minimum value, then the entity could be categorized as having no URL associated with it, a low percentage of likelihood of the entity having no URL, or indeterminate. It will be understood by one skilled in the art that one of these actions may be chosen based on a number of different factors including personal preferences or past results as indicators of the likelihood of future occurrences.

If the search results yield a number of hits greater than or equal to the minimum threshold, n, then the indexed content, such as the brief text description, is analyzed at 430. For example, typically, search engines, such as Google, include a brief text description immediately preceding and occurring after the matching text of the query attribute. The brief text description corresponds to indexed content of the web page. By analyzing the brief text description in the indexed content, the system obviates the need to download the content of the subject web page for further analysis. In this way, web page content can be analyzed, without having to expend system resources, such as bandwidth, because the actual web page does not need to be accessed each time it needs to process the web page content. If the brief text description does not provide conclusive matches, however, then the process may proceed to download the content from the web page.

At 435, the content of the web pages referenced by the first x number of URL addresses of the search result hits, starting with the highest-ranking URL, is retrieved. Email and website addresses (or other relevant attributes) are retrieved from the web pages at 440. The content is filtered for relevant attributes at 445. There are a number of filtering techniques that can be used to increase the accuracy of retrieving relevant content. For example, the system may filter the content for email and website addresses that are within a maximum distance (in ASCII characters) to the matching attribute. In this way, email and website addresses may be identified that are used possibly within the same context as the matching attribute, such as the telephone number of the entity. The system may also limit the number of matches of any one website address or email address identified to a count of two (once for a website and once for an email). In this way, one URL that lists the same website or email address several hundred times does not skew or bias the results. Further, the system may eliminate all email addresses that correspond to public email services, such as HOTMAIL. It should be understood that any technique that may eliminate misleading matches may be used.

At 450, the website addresses and email addresses that have been identified in the web pages are compiled (e.g. collected and counted). In particular, a running total of all of the collected email addresses and website addresses is determined. At 455, the compiled attributes are analyzed. For example, the total number of occurrence each website address and email address collected are analyzed, both individually and by combining emails and website addresses that have the same primary and secondary domain (for example, www.geosign.com and timnye@geosign.com may be considered the same). At 460, one or more website address for the entity is determined using the predictor module 40-1 of FIG. 1. The predictor 40-1 matches a website address when any one total is greater than the next nearest total by a factor of N1. N1 can be any positive number that is greater than 1 or is greater than one of the average/median/mean number of matches per URL by a factor of N2, where N2 can be any positive number greater than 1. If no total is greater then N1 or N2 and if there are more search result hits to process, than processes of 430 to 465 are repeated using the next URL in the set of matching search results (x). The x number is set to 1 from the original query matching URL, or using the next x number of URL addresses where x is set greater than 1. If at least one total is above N1 or N2 and n number of search result hits have been processed, then the matched website address(es) is provided. If all of the search result hits have been processed and no total exceeds N1 or N2 then the original entity is categorized as having (i) no URL associated with it; (ii) a low percentage of likelihood of having no URL associated with it; or (iii) indeterminate.

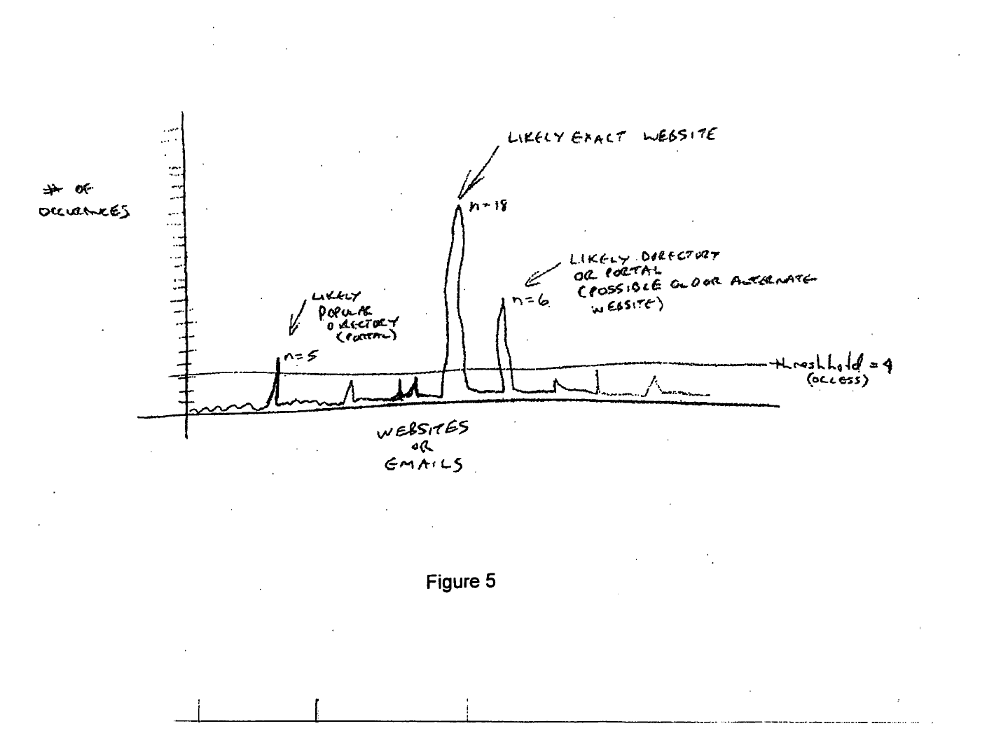

It is likely that N1 and N2 will be in a range of greater than 400% or a factor of 4 when there are a large number of search result hits. With several hundred samples, at least one or two website addresses will stand out as spikes in an X/Y graph as shown in FIG. 5. FIG. 5 illustrates a graph of counts (occurrences) versus URL addresses (websites and/or emails) of a sample result, where the main spike (n=18) is most likely to be the website address and the secondary spikes (n=5) and (n=6) are likely to be portals or directories.

When the number of search result hits is very small (total less than 20), then there may be website addresses with counts of 2 or even 1. To determine a match in this situation, criteria for the predictor module 40-1 may include a minimum number of search result hits for a match to be determined.

Database Integration

Referring to FIG. 1, there are a variety of databases 25-1, 25-2, . . . , 25-n, containing information that can be used by the distiller 40. These databases may be mailing lists, memberships lists, etc., that all share a commonality in that they are all collections of data that has been verified by independent sources. Examples of collections of data are members of the Better Business Bureau, members of the AARP, merchants that take Visa, doctors, or gas stations that take diesel. Such a collection of data may be used to create an enhanced search experience for the user.

One example, is using a list of doctors to determine whether any of the listed doctors makes house calls. The list in this example contains the names, addresses and phone numbers for all the doctors in each state. The user, via a query interface 30-1, queries the system 10 to locate a doctor that makes house calls in a particular region. The system 10 may use the phone number of each doctor to determine URL addresses that correspond to the doctors in the region of interest. Then, the system 10 may go to each URL and look for the phrase “house calls” or “we do house calls” and return the results that match the user's query. By initially providing a list of doctors, the system can ensure that any matches are at least doctors from the list. By way of contrast, a search on a generic search engine might return listings for a TV station advertising a comedy entitled, “house calls” or a medical journal discussing the effectiveness of “house calls.”

A user may provide their own database of entities 25-3 for the system to use as a search context. For instance, a user may provide a database of hotels rated 3 stars and above by the American Automobile Association (AAA). The AAA database of hotels may be crawled by the data extraction tool 30-4 to collect the data and indexed by the classifier 40-4. The AAA database may or may not include the URL addresses for the hotels, and the system 10 can be used to identify the corresponding URL address for each hotel entity in the AAA listing. The resulting index would be useful for a travel search engine to filter its search results through. For instance, executive travelers could make queries such as “pool”, “day care”, and “high speed internet access” knowing that all the results are hotels, and there are no mismatches from outside this list of hotels. The system 10 could identify the URL addresses associated with each hotel, and determine whether any of the hotel's websites include content that matches the user's search query.

The system 10 can determine URL addresses for entities based on information from a database provided by a user 25-3 by cross-referencing the database 25-3 against another collection of data, such as the Yellow Pages listings 25-1, which includes information about businesses, such as phone numbers. In this way, a database or listing containing verified information, such as the Yellow Pages database 25-1, can be used to determine URL addresses, even though the database 25-1 may not necessarily have URL ADDRESSES as attributes. In other words, if a list of entities is provided by a user 25-3, the system 10 can be used to identify the URL address of the entities by cross referencing the list of entities 25-3, with verified information, such as a Yellow Pages listing 25-1. Once the URL addresses are determined, the content at the respective websites may be crawled and indexed 25-4, and thus, used to determine to respond to a user's search query. With this technique, the system 10 can be used to generate highly targeted searches by cross-referencing and narrowing search results using this collection of information 25, 25-1, 25-2, . . . , 25-n. Collection of information may further include URL addresses that have been identified and classified, as well as their attributes (e.g. brand names, products, menu items, etc.) classified in accordance with the techniques described in U.S. application Ser. No. 10/856,351, filed May 28, 2004, which claims the benefit of U.S. Provisional Application No. 60/474,559 filed on May 30, 2003, the entire teachings of which are incorporated herein by reference.

Search Filters

In addition to specifying a search using attributes, the search may be further specified with a parser or search filter 40-3. Preferably, the system 10 includes a library of search filters 40-3 to focus search results in real-time. Each search filter 40-3 may correspond to specific subject matter. For example, a restaurant search filter may be provided that includes a specialized parser for restaurant related data. The user may type in “Italian food” as the query and instead of searching for the words “Italian food”, a parser might look for words such as “pasta, linguine, lasagna” and return matches for all URL addresses that contain these words.

A particular database may be selected based on the content of a user's query. For example, if a user inputs an “Italian Restaurants” query, a database may be selected that reflects the query. In this example, an appropriate database may be a restaurant database. A restaurant database may be generated, for instance, by extracting a list of restaurants from a Yellow Pages directory of restaurants. The URL addresses for the restaurants may be determined, and then a search for Italian food may be performed on the website associated with each URL. A similar technique, which uses the contents of a database as a geographic location filter to a query interface, is described in U.S. application Ser. No. 10/620,170, filed Jul. 15, 2003, the entire teachings of which are incorporated herein by reference.

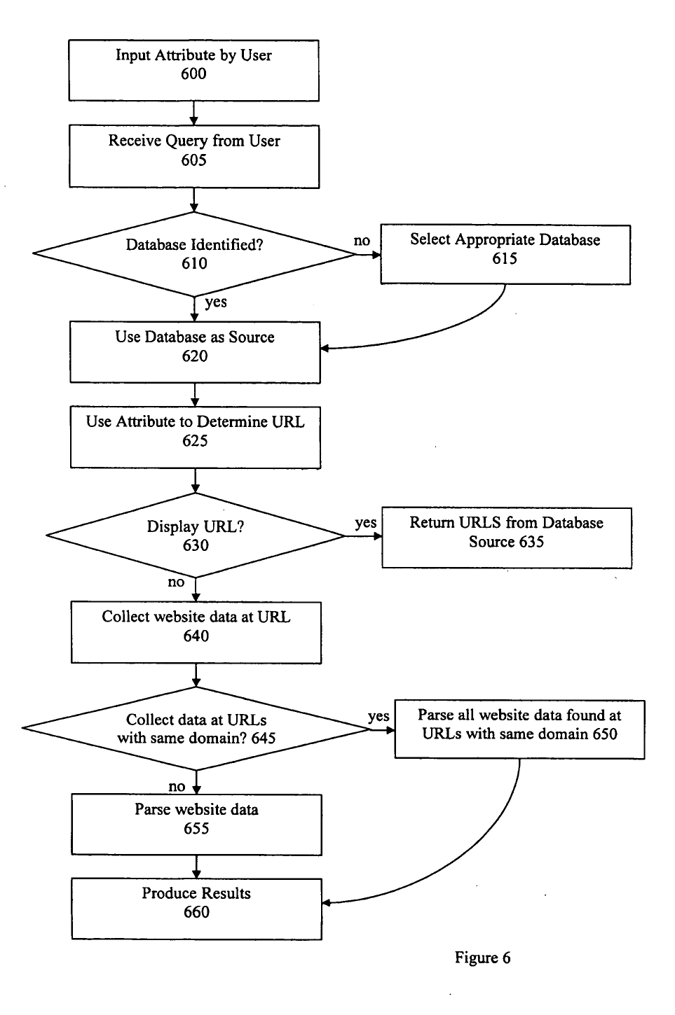

FIG. 6 shows the process for using a database as a filter for a search query according to an embodiment of the invention. Referring to FIGS. 1 and 6, at 600, a user inputs an attribute of as a query interface 30-1. The attribute may be a phone number of a business, a phrase (e.g. “Italian food”), etc. At 605, the search query is received by the system 10. At 610, the system 10 determines whether a database 25 has been identified. A particular database is selected by the user 25-3. If a database has not been selected, than at 615, the system chooses an appropriate set of records that reflect the user's query. At 625, the process determines candidate URL addresses that correspond to the queried attribute or correspond to the appropriate set of records from 615. The URL addresses can be determined by database lookup 25 or by using the distiller 40 to determine the appropriate URL address that corresponds to the query. At 630, the user has the option of receiving the potential URL addresses so they can visit the website on their own. Otherwise, at 640, the system collects the data from the websites associated with the potential URL addresses. This can be performed by crawling 30 the web pages and collecting raw data. At 645, the system may collect data from other web pages associated with the URL address's domain name using the domain name analyzer 40-2. At 655, the system 10 processes the website data, based on the user's query. The data may be filtered or processed through a produced to only return certain portions of the data, and the technique used to deliver this data could vary (e.g. voice, email, or video). The system 10 identifies matches and returns the results at 660. The distiller 40 and its related components 40-1, 40-2, 40-3 may process the results to eliminate false positives and determine the most likely match.

Determining Information About an Entity

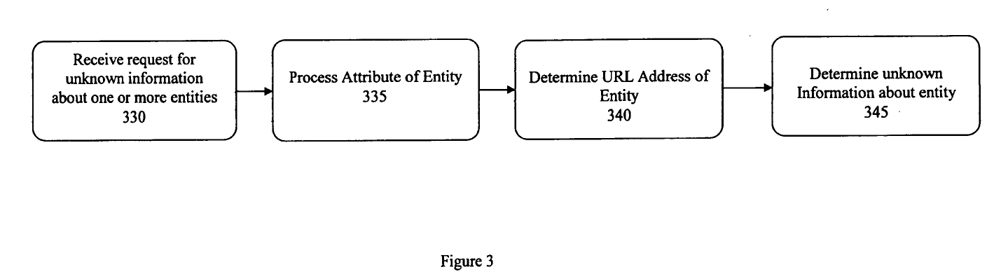

FIG. 3 is a flow diagram of a process for identifying unknown information about an entity. At 330, a request for unknown information is received. A user may request menu information for restaurants located in a specific geographic location. For example, the user may request information about restaurants that serve a particular meal. The process may determine relevant attributes, such as attributes of restaurants in the geographic location (e.g. the business name or telephone number of the desired restaurant obtained from yellow pages database). At 335, the attribute information is processed. The attribute, for example, can be used to look-up one or more records in the database, which are associated with the entity. At 340, the URL address associated with the entity is determined. The URL address may be identified in a database in connection with the record associated with an entity. If the URL address is not identified in the database, the system 10 of FIG. 1, for example, may be used to identify the website address of the entity. Once the URL address of the entity is identified, the entity's website content can be extracted and used to determine the unknown information at 345. For example, the content of a restaurant's website may be parsed to determine whether the restaurant serves the meal. Any restaurants satisfying the user's query would be provided to the user.

Input Devices

Referring to FIG. 4, various devices may be used to input an attribute at 400. Such devices include as an application running on a portable device. For example, the device may be a RIM pager or Palm Pilot running a program such as Vindigo, that provides address information about businesses near a user, using some form of menus or categories. The user may desire to obtain information about a business within a certain distance from his location. However, the information provided to him on that business is usually just the location of the business on a map, an address, and possibly a telephone number and/or some other basic attributes. According to an aspect of the invention, the user may identify any point of data displayed on the device using a variety of programmable methods (e.g. mouse, stylus, voice, touch) and request more information on the identified point of data. The data identified may be linked to a telephone number (or submitted). Using the data identified, a website address is determined. Data is downloaded from the website and presented to the user.

A smart agent or bot may be used to analyze the downloaded data prior to displaying it to the user in order to anticipate the information that may be of interest to the user. For example, if a user inquires about a particular restaurant, the smart agent may determine the website address of the restaurant, parse the contents of the restaurant website for menu descriptions, and return a query to the user asking if the user would like to view the menu. Alternatively, the smart agent may analyze the menu to determine if the restaurant is a low priced restaurant or high priced, and thus, determine if the user would enjoy the restaurant or not.

For a clothing store, the smart agent may search for certain brands that the user may have previously indicated an interest in, or find general specials to present to the user.

Further, the user may not even have to select the data point but rather may use a communication device, which is in the user's possession such as one built into a car, a cell phone or other portable device that has some global position system (GPS) or positioning ability. In this case, as the user moves around, the local entities in the area are located by a database of telephone numbers or other attributes, the website addresses are identified, and the contents of their websites are downloaded on the fly and presented to the user, or processed at some location so that when the user performs a query, the local data is already freshly indexed. Thus, the user may be able to have Internet content within a set range (e.g. 10 miles) available either locally in their communication device, or on a central server, which can easily be queried by the user. As will be appreciated, this process saves a large amount of query time when the user needs local information. This also ensures that the information is current. Currently, queries to a search engine are only as current as the latest update or spider performed by that search engine, which may be good for some websites, poor for others, and non-existent for others.

In another example, a user may provide an attribute, such as a telephone number, over a wireless telephone device. The system may determine the website address of the entity, which corresponds to the phone number, and cache the relevant content of the website. In this way, the content from the website, such as menu information or store specials, are provided via a WML browser (if their device and the website are so compatible) or by reading the text using common text to voice technology.

An intelligent web agent may also be used to read the web content linked to a URL in real time and intelligently construct an option to a user based on the read web content. For example, if a user was to ask for the telephone number of a restaurant, the system 10 of FIG. 1 may determine the URL, read the web content and ask the user, “Would you like to hear/access their menu?”. If the query was for a department store, or a clothing store, the question generated might be “This store has a sale today on ProductX. Would you like to order one?” Note that in this second case, the process is further enhanced as the intelligent agent is able to recognize the online ordering process for the business and cross reference that with the web content so that the user can actually interface with the website.

Rating System

In another example, a rating system is provided that identifies websites that are relevant or irrelevant. For example, the rating system may consider the date that website content has been last updated when determining whether the site contains relevant content. The user can be alerted to websites that contain current content. A smart agent may also generate time dated comments such as “This business has not updated its website in over six months”. The last updated date can be determined by examining when web page was last cached or by comparing the content of the website with content archived at an internet archival site. The last updated date could be used on its own or combined with other generated facts from both online and offline businesses to provide a rating for a store, so that stores with high ratings could be queried. This would improve customer service, lead to faster web updates and lower prices as user feedback would drive businesses to be more competitive.

Language Independent

It will be appreciated by those skilled in the art that the source of the input language is irrelevant. Any attribute provided by the user can be linked to a telephone number and, therefore, as numbers have no language dependence, they can be linked to a website that may contain content in any language. This content may be read back to the user in the original language of the user or in the language that the content is written in, or in any language. The ability to read back the web page (deliver the content of the website) in the same language as the user is accomplished by determining the language of the user initially. This can be done very easily if the user says a telephone number using a language database capable of recognizing numbers in several languages.

Alternatively, this also could be accomplished through user input. The user may be asked to select a language (e.g. one for English, deux pour francais) and the selected language recorded. Once the query is made by the user (attribute is supplied), the query is matched to a telephone number using either automated or human methods, and from the telephone number the website is located using one of the techniques described herein. Once the website is determined, using the intelligent agent, the web content is read back to the user using a text to voice program. An attribute may be received via voice or Internet and in response, a website returned by either looking the website up in a database associated with that attribute or by performing a real-time process such that the website address is determined from the attribute in accordance with one of the above described methods.

Current Content

When a query for a website address is looked up in the database 25, the system 10 may revise any content associated with the website address, which has been stored in the database 25. For example, the system 10 may determine that data stored in the database 25 is stale (i.e. the website was last updated beyond a certain time period), and therefore, the system may spider the content of the website using a data extraction tool 30-4 to ensure that the content stored in the database 25 is up-to-date. Alternatively, the system 10 may up-date the content stored in the database in response to a search query. Thus, the currency of such databases 25 is maintained since they are updated. This enables the system 10 to ensure that its collection of information 25 is as up-to-date as the content on the web.

The ability to use up-to-date web content enables the system 10 to provide users with a better information retrieval service. Conventional processes often access static resources, such as databases, and do not rely content extracted from the web. The present invention, however, supplements its databases 25 with information about businesses extracted from their respective websites and, therefore, is able to maintain up-to-date information about businesses.

Enhancing Information Services

According to an aspect of the invention, a user is able to obtain an Internet address for a business when they request the telephone number of the business from an information service (e.g. telephone directory assistance). A user, for example, may be prompted to answer questions based on the calling device used. The system may also recognize the type of calling device. For example, the system may determine whether the telephone is based on 3rd generation (3G) technology, whether the user is calling using a computer headset on a PC, or whether the telephone has a color display or is a hybrid telephone/personal assistant type device. Further, the user may be presented with different options based on their input. For example, a user with a RIM pager would be offered, “Press 7 to add this information to your address book. There will be a 75 cent charge for this service.” A user with a 3G color telephone who is calling about the nearest theatre would be offered, “Press 7 to view a trailer of the current movies showing now.” This feature would not be offered to someone calling on a normal telephone which cannot display video.

The content from a website, or other content, may be downloaded into the memory or hard storage in the user's calling device for offline viewing. The downloaded content may be stored in a location which may be used to trigger a future action. For example, a user uses an “information service” and requests the telephone number for a specific restaurant using a 3G, which has the ability to run applets. The telephone number is provided and the user may be offered various choices. When the telephone number is retrieved, the system may also determine the URL address of the business that corresponds to the telephone number. The system may then determine businesses that offer similar goods and services using its databases, such as the Yellow Pages database. Smart advertising, which downloads an applet to the user's device that contains an advertisement (or other actionable item) relating to businesses that offer similar services and at a particular location, may then be used. The location may be determined based on the area code of the telephone number of the entity requested by the user, or by a positioning device associated with the user's telephone.

In another example, a user utilizes a telephone to dial a telephone number (e.g. 1-800-website) for automated access where the user could then type in the telephone number of the business or speak the telephone number into the telephone and have it converted, and then the user would be provided with the information about the entity that corresponds to the telephone number. For example, the URL address of the entity's website may be provided. Portions of the website of the entity may be provided to the user using an intelligent agent or a menu system. For example, if the entity is a restaurant, the system may provide the user with a menu extracted from the restaurant's website. Further attributes may be provided, such as the price range or reviews of the restaurant, which have been extracted from other information portals. If audio tag is defined on the website of the entity, the system could recite the embedded information to the user. The text-to-voice preferences may be defined by the user, or may be processed from the audio tag on the website. For instance, the voice tag may include <tag audiotag voice=“Female Serena” Content=“Buy one entrée get one free tonight at the Steakhouse!”>. In a further embodiment, the voice used to recite embedded text may reflect the dialect or accent of the caller. The accent may be determined by analyzing the caller's initial voice query so as to provide a more positive customer experience and to ensure clearer communications as people tend to understand better the speech of others with the same accent.

In another example, the system can interface with an information service, such as 411, to provide a user with information about an entity. The system can seamlessly integrate into each information service and enhance their services. For instance, the 411 information service may be supplemented by offering the user the option to obtain the website of a desired entity (e.g. “Press 9 for the website of this business”). Currently, the only technical way to do this is to have a database of websites and telephone numbers or business names, and perform a table lookup. Unfortunately, such databases are not available today in any complete form. Their content is often limited. Further, they are expensive to maintain because they typically require human assistance to identify a business's URL address and store it in a database. Because information tends to be dynamic, especially information available online, it is important to update and maintain such databases, and this maintenance can be cost prohibitive. However, according to aspects of the invention, a database of websites corresponding to entities may implemented according to processes and systems described in FIGS. 1-6. Because the system can provide an up-to-date database storing attributes of an entity, existing services can supplement their services with this up-to-date information. The system may be used to create and update a database, and thus, verify its contents prior to submitting them to a user in response to a user's query.

If, for example, a user accesses the system, using a program such as Vindigo or other supported wireless device, and requests a list of all restaurants with a 4 star rating within 5 miles of them, the search results are displayed as a list of restaurants meeting the criteria. For example, the user selects the name for “Restaurant A” and selects “web”, the software may respond by invoking one of the above described methods, which first checks to see if the search result hit is already in the database, and/or otherwise performs a real-time lookup to locate the URL address of the website, and then if the user's device supports web browsing, loads the corresponding website or otherwise returns the URL linked to Restaurant A's website.

Alternatively, the process allows the user to query the system for a particular string if they do not have web browsing ability. The ability to do this already exists on the web (e.g., google plugin) but requires the user be on the Internet. With the up-to-date database, however, the present system enables the user to perform this query offline (e.g. without being connected to the Internet or the website).

In addition, the user can highlight several displayed entities, and ask for the list to be filtered by a particular keyword. For example, the user highlights ten seafood restaurants and wants to see which ones serve “sea bass”. The system 10 locates the websites, searches them for the words “sea bass” and then returns the matches in some form of user interface.

Regardless of the whether the user actually selects a telephone number or an entity, or is simply looking at a map and points at an icon on the map, the system 10 may attach attributes to that icon, which may be an entity name or telephone number, or that the entity name may in turn have an attribute of a telephone number. This enables the process of going from icon to entity to telephone to the distiller engine to web content (or to any attribute or information requiring web) or the process of going from icon to the distiller engine 35 directly and to web content 55.

A string of text or voice can also be parsed for semantic meaning and/or a one word input can be used to query 30-1 all the matching entities (assuming that the geographical location is known) in the current online Yellow Page listings 25-1. The group of telephone numbers can then be used to identify a group of potential websites and a response back can be formulated based on querying of these websites.

For example, a user requests “restaurants” and from the wireless device location, the system determines that the user is located in downtown Toronto at a particular latitude and longitude. The system looks up all the matches it has for restaurants and returns a set of names and telephone numbers. If websites are known for all these entities from the database, than the addresses are provided. Otherwise, the distiller 40 determines the websites for the requested entities. When a set of websites is located (not all entities may have websites) the content of the websites is downloaded into memory and processed with some form of avatar process to provide an intelligent user response based on the content contained on the websites. This experience can augment any system. The user is then able to interact with the website content of the restaurants through user prompted questions or free flow questions depending on the level of available semantic processing.

It should be noted that the headings used above are meant as a guide to the reader and should not be considered limiting in any way.

While this invention has been particularly shown and described with references to preferred embodiments thereof, it will be understood by those skilled in the art that various changes in form and details may be made therein without departing from the scope of the invention encompassed by the appended claims.

For example, aspects of the invention can be used to identify a collection of email addresses for an entity. When a website address of an entity is first determined, emails that were collected in the process of determining the website address of the entity that had the same domain name are returned. For example, if a telephone number 555-456-7890 returned WWW.BUSINESSONE.COM as the website address, then BRIAN@BUSINESSONE.COM and FREDC@7BUSINESSONE.COM are considered to be email address matches. In this way, a user may be provided with relevant email addresses of the entity.

It will also be understood by those skilled in the art that the present invention may also be used to collect various other attributes associated with the website once the website is identified.

It will further be understood by those skilled in the art that the use of email addresses is not required to implement the invention, but supplements the collection of website addresses. The collection of email addresses in addition to website address provides a greater confidence level when determining a website address of an entity.

1. A computer implemented method of identifying a url address of an entity comprising:
receiving a request for a URL address of an entity;
selecting a verified attribute associated with the entity; and
using the verified attribute, searching for potential URL addresses of the entity.

2. A computer implemented method as in claim 1 wherein the verified attribute is a telephone number of the entity.

3. A computer implemented method as in claim 1 wherein the verified attribute is obtained from a persistent storage, that includes verified information about a plurality of entities.

4. A computer implemented method as in claim 3 wherein the persistent storage includes at least one of: yellow pages database, white pages database, membership list or business information database.

5. A computer implemented method as in claim 1 wherein the verified attribute is verified by an independent source that is any yellow pages database, white pages database, membership list, global positioning device, or telephone service.

6. (canceled)

7. A computer implemented method as in claim 1 wherein searching for potential URL addresses of the entity further includes:
querying one or more search engines using the verified attribute; and
obtaining search result hits.

8. (canceled)

9. A computer implemented method as in claim 7 further includes analyzing URL addresses of at least a portion of the hits including processing one of the URL addresses by comparing the URL address with a business name attribute of with the entity.

10. (canceled)

11. A computer implemented method as in claim 9 wherein processing one of the URL addresses by comparing the URL address with a business name attribute of the entity further includes:
quantifying a degree of similarity between the business name attribute of the entity and the URL address; and
assigning a confidence level to the URL address based at least in part on the degree of similarity between the business name attribute of the entity and the URL address.

12-14. (canceled)

15. A computer implemented method as in claim 9 wherein processing one of the URL addresses by comparing the URL address with a business name attribute of the entity further includes:
determining that the URL address is a potential match based on the results of the comparison;
extracting website content associated with URL addresses of at least a portion of the hits; and
using the website content to verify the potential match.

16. A computer implemented method as in claim 9 wherein analyzing URL addresses of at least a portion of the hits further includes:
determining whether one or more of the URL addresses corresponds to a homepage; and
if a URL address corresponds to a homepage, increasing a degree of confidence associated that the URL address is a potential URL address of the entity.

17. A computer implemented method as in claim 7 wherein obtaining search results further includes analyzing website content of at least a portion of the hits by:
identifying electronic addresses in the website content, where the electronic addresses are any URL addresses or an email addresses: and
computing a total number of occurrences for each electronic address identified: and
ranking the hits based at least in part on the computed totals.

18-19. (canceled)

20. A computer implemented method as in claim 17 wherein computing a total number of occurrence for each electronic address identified further includes:
analyzing the electronic addresses identified in the website content to determine whether any URL address and email address have the same domain name; and
responding to determining that a URL address and email address have the same domain by processing the URL address and email address having the same domain as a single occurrence.

21. (canceled)

22. A computer implemented method as in claim 17 wherein identifying electronic addresses in the website content further includes:
collecting website content associated with one or more of the electronic addresses; and
filtering the content for relevant attributes known about the entity; and
analyzing the relevant collected website content to determine whether each of the electronic addresses identified is within a maximum distance from the relevant attributes.

23-24. (canceled)

25. A computer implemented method as in claim 7 wherein obtaining the search results further includes eliminating false positives from the search results by comparing URL addresses identified in the search results against a collection of URL addresses that correspond to false positives, where the false positives are any URL addresses corresponding to portals or directories.

26. (canceled)

27. A computer implemented method as in claim 25 wherein the collection of URL addresses that correspond to false positives is created by:
identifying suspect URL addresses that include website content referencing a plurality of verified attributes of a plurality of entities; and
determining that the suspect URL addresses are false positives.

28. A computer implemented method as in claim 1 wherein the request for a URL address of an entity further includes an attribute of the entity that is not the same attribute as the verified attribute.

29. (canceled)

30. A computer implemented method as in claim 1 wherein the entity is any one of the following: a business, organization, enterprise, or agency.

31. A software system for identifying a URL address of an entity comprising:
a search handler receiving a request for a URL address of an entity;
a search process, in communication with the search handler, responding to the request by selecting a verified attribute to use in a search query; and
the search process analyzing results of the search query to identify the URL addresses of the entity.

32. (canceled)

33. A software system according to claim 31 wherein the attribute list includes at least one of the following: telephone number of the entity, a name of the entity, a physical address of the entity, or any information about the entity.

34-35. (canceled)

36. A software system according to claim 31 wherein the verified attribute is obtained from any yellow pages database, white pages database, membership list or business information database.

37-38. (canceled)

39. A software system according to claim 31 wherein the search process further includes logic for:
passing the verified attribute to a plurality of independent search engines;
processing search results received from the plurality of search engines; and
determining whether the search results provide a minimum number of hits.

40. A software system according to claim 31 wherein the search process analyzing results of the search query to identify the URL address of the entity further includes:
a tuner, in communication with the search process, the tuner filtering the results of the search process to identify candidate hits; and
a confidence, assigned by the tuner to each of the candidate hits, where the confidence reflects a degree of certainty as to whether a respective candidate hit corresponds to the entity.

41. A software system according to claim 40 wherein the confidence assigned by the tuner is determined at least in part by:
a string matching process quantifying a degree of similarity between a business name associated with the entity and a URL address of a respective candidate hit; and
the string matching process identifying a pattern in the business name and the URL address of the respective candidate hit by comparing a character string extracted from the business with a character string extracted from the URL address of the respective candidate hit.

42-45. (canceled)

46. A software system according to claim 39 wherein the search process processing search results received from the plurality of search engines further includes:
a data extraction tool for extracting content website content associated with one or more of the search results;
a parser, in communication with the data extraction tool, to parse the extracted content of one or more of the search results;
a predictor, in communication with the parser, to compute a number of occurrences that a respective URL address and a respective email address appear in the extracted content of a respective search result; and
a domain analyzer, in communication with the predictor, to analyze each URL address and email address identified in the extracted content of a respective search result.

47. A software system according to claim 46 wherein the domain name analyzer includes logic to disregard public email addresses.

48-49. (canceled)

50. A software system according to claim 39 wherein the search process further includes logic to eliminate false positives in the search results by comparing the search results against a database of false positives.

51. A software system according to claim 50 wherein the database of false positives further includes URL addresses that correspond to websites for directories or portals.

52. A software system according to claim 50 wherein the database of false positives is developed by searching for URL addresses that correspond to websites, which provide a plurality of verified attributes about a plurality of entities.

53. (canceled)

54. A system for identifying a URL address of an entity comprising:
means for receiving a request for a URL address of an entity;
means for selecting a verified attribute associated with the entity; and
means for using the verified attribute, searching for potential URL addresses of the entity.

55-79. (canceled)
